(19) United States
(12) Patent Application Publication
(10) Pub. No.: US 2019/0283849 A1
(43) Pub. Date: Sep. 19, 2019

(54) METAL POLYMER COMPOSITE FOR MAKING BALANCING WEIGHTS FOR APROPELLERS AND METHOD OF MAKING AND USING THE SAME

(71) Applicant: Tundra Composites, LLC, White Bear Lake, MN (US)

(72) Inventors: Scott Bohnen, Stillwater, MN (US); Kurt Heikkila, Marine on the ST. Croix, MN (US)

(73) Assignee: Tundra Composites, LLC, White Bear Lake, MN (US)

(21) Appl. No.: 16/353,128

(22) Filed: Mar. 14, 2019

Related U.S. Application Data
(60) Provisional application No. 62/643,943, filed on Mar. 16, 2018.

(51) Int. Cl. B63H 1/28; B29B 7/90; B29C 48/00; B29C 53/02; B29C 53/00; C08K 3/10

(52) U.S. Cl. CPC B63H 1/28; B29B 7/90; B29C 48/022; B29K 2101/12; B29C 53/02; B29C 53/005; C08K 3/10; B29C 48/0022

(57) ABSTRACT

The embodiment relates to a balanced propeller and to an extrudable metal polymer composite and process for making and using the composite to make balancing weight strips for marine or boat propellers. Metal particulate of adequate particle size is mixed with a polymer that is extruded or injection molded to form a high-density weighted strip.

### CROSS-REFERENCE TO RELATED APPLICATTIONS

This application claims the benefit of U.S. Provisional Patent Application Ser. No. 62/643,943, filed Mar. 16, 2018, herein incorporated by reference in its entirety.

### FIELD

This disclosure relates to composites that can be extruded into useful shapes with an increased density as a balancing weight for a marine propeller.

### BACKGROUND

High density materials have been made for many years for balancing spinning objects such as automobile wheels. Lead has been commonly used in applications requiring a high-density material. Applications of high density materials include shotgun pellets, other ballistic projectiles, fishing lures, fishing weights, wheel weights and other high-density applications. Lead and other materials have also been used in applications requiring properties other than density including in radiation shielding because of its resistance to EMI and malleability characteristics. Composite materials have been suggested as a replacement for lead and other high-density materials. Composite materials have been made for many years by combining generally two dissimilar materials to obtain beneficial properties from both.

A true composite is unique because the interaction of the materials provides the best properties of both components. Many types of composite materials are known and are not simple admixtures. Generally, the art recognizes that combining metals of certain types and at proportions that form an alloy provides unique properties in metal/metal alloy materials. Metal/ceramic composites have been made typically involving combining metal particulate or fiber with clay materials that can be fired into a metal/ceramic composite.

Tarlow, U.S. Pat. No. 3,895,143, teaches a sheet material comprising elastomer latex that includes dispersed inorganic fibers and finely divided metallic particles. Bruner et al., U.S. Pat. No. 2,748,099, teach a nylon material containing copper, aluminum or graphite for the purpose of modifying the thermal or electrical properties of the material, but not the density of the admixture. Sandbank, U.S. Pat. No. 5,548,125, teaches a clothing article comprising a flexible polymer with a relatively small volume percent of tungsten for the purpose of obtaining radiation shielding. Belanger et al., U.S. Pat. No. 5,237,930, disclose practice ammunition containing copper powder and a thermoplastic polymer, typically a nylon material. Epson Corporation, JP 63-273664 A shows a polyamide containing metal silicate glass fiber, tight knit whiskers and other materials as a metal containing composite. Bray et al., U.S. Pat. Nos. 6,048,379 and 6,517,774, disclose an attempt to produce tungsten polymer composite materials. The patent disclosures combine tungsten powder having particle size less than 10 microns, optionally with other components and a polymer or a metal fiber. Barbour et al., U.S. Pat. No. 6,411,248, discloses using a glue-gun applied hot-melt radar-absorbing material, including carbonyl iron powder in thermoplastic polyurethane and a unique metal deactivator in amounts useful for a specific application.

An extrudable thermoplastic high-density non-toxic metal composite material has not been obtained that can be used to form balancing weights for motorized marine (boat) propellers that do not increase cavitation or disturb the flow of either the exhaust gasses if present or the fluid water, over and around the propeller blades. Further, such weights are environmentally friendly as they do not contain lead or other environmentally toxic materials.

Presently, to balance a propeller used on a motorized boat, substantial labor, time, and technique is required to obtain a propeller that is balanced. A properly “balanced” propeller operating at high revolutions per minute does not generate any undo strain on the motor or boat nor are there any destructive vibrations generated by the propeller during operation in water of the motorized boat. With balancing, the propeller is operating at optimal power/efficiency and providing higher miles per gallon versus a motorized boat utilizing an unbalanced propeller.

A substantial need exists for an extrudable material that has high density, low toxicity, and improved properties in terms of balancing and maintaining laminar water flow around propeller blades and the propeller assembly during operation on a motorized boat.

### SUMMARY

In an embodiment a balance weight is placed on a marine propeller.

In an embodiment a thermoplastic composite material is adapted for forming a weighted strip placed on a marine or boat propeller, the thermoplastic composite material comprising a composite comprising:

(a) a thermoplastic polymer phase comprising about 5 to 25 wt. % and 25 to 75 vol. % of the composite; and

(b) a metal particulate comprising about 75 to 95 wt. % and 25 to 75 vol. % of the composite and intermixed with the polymer phase, the particulate having a particle size where no more than 10 wt. % of the particles are under 10 microns; wherein the particulate and polymer phase are formed into the weighted strip, the weighted strip having a Reynolds number producing laminar flow across the strip during operation of the boat propeller.

In an embodiment the composite has a coating of an interfacial modifier on the surface of the metal particulate.

In an embodiment, the propeller is placed on a balancing machine and its balance weight requirement is measured. This requirement is a combination of a placement location and a weight needed for a smoothly spinning propeller. In this context, a strip of the correct weight is selected and placed at the proper placement location. The term “strip” refers to a weighted strip of defined weight. Such a weight can be obtained by either (1) cutting a roll of indeterminate length into a strip of the correct weight, or (2) selecting a useful weight from a premade assortment of strips made through any useful thermoplastic processing technique. The strip selected has the correct mass for proper balance and optionally has a curvature on at least one surface to promote adhesion to an adjacent, separate surface. An opposite surface is designed to promote a laminar flow across said surface.

In an embodiment, the weighted strip has a leading edge that is less than 45°.

In an embodiment, the weighted strip has a trailing edge that is less than 45°.

In an embodiment, a process of manufacturing a weighted strip to balance a motorized boat propeller from a metal particulate and polymer composite, the process comprising:
a. Combining a thermoplastic polymer phase;
comprising about 5 to 25 wt. % and 25 to 75 vol. % of the composite; and
b. Mixing a metal particulate comprising about 75 to 95 wt. % and 25 to 75 vol. % of the composite with the polymer phase, the particulate having a particle size of no more than 10 wt. % under 10 microns; wherein the particulate and polymer phase comprise greater than 95 vol. % of the composite.
c. Extruding the composite into a linear extrudate.
d. Selecting a balancer setting such as clip/clip, clip/tape, or tape.
e. Measuring a width and a weight of the propeller.
f. Balancing the propeller on the balancer.
g. Determining an out-of-balance weight and a location(s) on the boat propeller.
h. Cutting the propeller weight strip material to a needed weight.
i. Locating the propeller weight strips(s) to the correct position on the propeller.
j. Pre-bending the propeller weight(s) to conform to a portion of the circumference inner portion of the hub to fit to the curvature of the inner portion of the hub.
k. Smoothing a leading edge(s) of the weight strip so that the leading edge(s) is less than 45° relative to the base of the inner hub.
l. Rechecking the balance of the propeller with the weighted strip.

The term “marine” means that the use environment for the balanced propeller is in fresh or salt water. The propeller can be used as a mode of propulsion or any other need for moving a fluid stream such as a coolant stream, exhaust gasses or a cleaning stream. The term “particulate” refers to a collection of finely divided particles. The particulate has a range of sizes and morphologies. The maximum particle size is less than 500 microns. The particulate, coated with interfacial modifier, is dispersed into a thermoplastic polymer. A formed body containing the interfacially modified particulate is used to form a desired object. For this disclosure, the term “metal” relates to metal in an oxidation state, approximately 0, with up to 25 wt.-% or about 0.001 to 10 wt.-% as an oxide or a metal or non-metal contaminant, not in association with ionic, covalent or chelating (complexing) agents.

For this disclosure, the term “particulate” typically refers to a material made into a product having a particle size greater than 10 microns (a particle size greater than about 10 microns means that a small portion of the particulate is less than 10 microns, in fact, less than 10 wt.-% of the particulate and often less than 5 wt.-% of the particulate is less than 10 microns. A particulate is chosen containing at least some particulate in the size range of 10 to 4000 microns. In a packed state, this particulate has an excluded volume of about 13 to 60%. In this disclosure, the particulate sources can also comprise blends of two three or more particulates, in a blend of metals of differing chemical and physical nature. Sizing of the metal particulate can be determined by techniques known in the art such as sieving.

In this disclosure “balanced” means, relative to a propeller, for example, on a motorized boat, that no portion of the propeller is asymmetric with respect to weight. The blade should not be heavier than another blade nor any another part of the propeller assembly be asymmetric to the extent to cause detrimental vibration or other detrimental event to the operation of the motor or the boat.

In this disclosure “laminar flow” means, relative to a propeller or propeller surface, for example, on a motorized boat, that water flows over a propeller blade or other propeller part, such as the hub, is sheet-like and not turbulent. The sheets or layers of, for example, water, show no disruption between or among layers when flowing over the propeller comprising the balance weight made of the composite material. Laminar flow can be measured by a Reynolds number that has a value between about 1000 to 4000. In certain embodiments, the Reynolds number is <2300.

### BRIEF DESCRIPTION OF THE DRAWINGS

FIG. 1 is an isometric view of the trailing portion of the propeller.

FIG. 2 is an isometric view of the leading edge of the propeller system.

FIG. 3 is a plan view of the trailing portion of the propeller system.

FIG. 4 is the side view of a propeller system.

FIG. 5 shows a plan view of the leading edge of the propeller system.

FIG. 6 is an isometric view of the balance weight adhesive strip system.

FIG. 7 is a top view of the weighted balance adhesive strip system.

FIG. 8 is an end view of the balance weight adhesive strip system.

FIG. 9 is a top view of the adhesive of the balance weight adhesive strip system.

FIG. 10 is an isometric view of the balancing weight adhesive strip system.

### DETAILED DESCRIPTION

As used in this disclosure, a propeller is a device having a hub that revolves, the hub comprising radiating blades. A propeller provides a mechanism for moving, for example, an airplane or a ship through a fluid such as air or water. In other instances, the propeller may not be moving an object but can be moving the fluid, i.e. air, steam, gas, water or other fluid. In these examples the propeller can be labelled a wind mill (air), an impeller (water), or a turbine (air, water or oter fluid).

Disclosed are a balanced marine propeller, a non-toxic composite balance weight, a method of balancing, and a process of manufacturing enhanced density composites using such processes and methods of making high density composite weighted strips for balancing a boat or ship propeller operating at high revolutions per minute (RPM). The functional effectiveness of these strips is governed by keeping a Reynolds number (Re) at a level that provides a laminar flow of fresh or salt water over the boat propeller balancing weight strip. Enhanced density denotes a material that obtains a useful aspect from its density that is typically greater than 2 gm-cm⁻³. The useful aspect form, the weighted strip, for the balancing weight on the motorized boat propeller, has leading edges that are rounded or angled to produce a laminar flow of water over the strip during operation of the propeller. Further a curvature on at least one surface of the weighted strip conforms to the curvature of the propeller hub. In another aspect, the strip(s) can have any workable cross-section and can be adapted to fluid flow, circular, square, or rectangular. More than one strip could be applied to the boat propeller to complete the balancing of the propeller. All strips, regardless of shape or dimension, must have an Re that provides laminar flow of a fluid, such as, for example, water, across the strip at high propeller rpms. Such a weight could be useful for other fluid moving devices such as, for examples, impellers, turbines, or wind mills and such embodiments are contemplated in this disclosure.

The material of the disclosure, through a selection of metal particle, polymer and processing conditions, attains improved thermoplastic processability. The resulting composite materials exceed the prior art composites in terms of reduced toxicity, melt viscosity, improved viscoelastic properties (such as tensile modulus, storage modulus, elastic-plastic deformation and others) electrical/magnetic properties, and machine molding properties. We have found that the composite materials of the disclosure can have a designed level of density, mechanical properties, or electrical/magnetic properties from careful composition blending. The novel viscoelastic properties make the materials useful in a variety of uses not filled by composites and provide a material easily made and formed into useful shapes. In the production of useful enhanced properties, the packing of the selected particle size and distribution and the selection of the particulate or mixed metal particulate, will obtain the enhanced properties. As such, the density can be used as a predictor of the other useful property enhancement. The disclosure relates to an extruded enhanced metal polymer composite material having improved properties with respect to prior art materials. Single metal and mixed metal composites can be tailored for increasing a variety of properties including but not limited to density, color, magnetism, thermal conductivity, electrical conductivity and other physical properties. The use of compositions further comprising an interfacial modifier demonstrates improved utilization of material properties and improved performance such as elongation, shaping, and other properties.

Preferred composites can be combined with one or more polymers of a given molecular weight distribution and one or more metal particulates with a given distribution to obtain unique composites. Briefly, the metal polymer composites of the disclosure can be extruded into a high-density material comprising a high-density metal particulate, a polymer, and an interfacial modifier (IM) material. In one embodiment, a metal thermoplastic composite can be made into a weighted strip that is useful for propeller balancing weights such a propeller being used on a boat for propulsion.

The proportions of metal particulate and polymer in the composite achieve the minimum excluded volume filled with polymer, the highest particulate packing densities, the maximize polymer composite material and obtain the maximum utilization of materials. The particle shape, size and distribution of the metal component are controlled to maximize the extruded composite density and other properties. The high-density materials of the disclosure can contain about 0.005 to 1% of a pigments, dye or other fluorescent material or other ingredients to modify the visual appearance of the materials. Mixed metal or alloy metal composites can be used to tailor densities for specific uses. Aforementioned properties include but are not limited to density, thermal properties such as conductivity, magnetic properties, electrical properties such as conductivity, color, etc. Preferred higher density metal polymer materials can also be combined with one or more polymers and one or more metal particulates to obtain unique composites.

A secondary metal can be combined with a metal of high density. A composite can comprise a variety of different combinations of metals and polymers. The metal particulate can contain two metal particulates of different metals, each metal having a relatively high density. In another embodiment, the metal particulate can comprise a metal particulate of high density and a secondary metal. Such properties can include electrical properties, magnetic properties, physical properties, including heat conductivity, acoustical shielding, etc.

Examples of useful metals include, but are not limited to, tungsten, iron, steel, stainless steel, iron alloys, copper, nickel, cobalt, bismuth, tin, cadmium and zinc. The materials of the disclosure permit the design engineer the flexibility to tailor the extrusion process and the extruded composite to end uses and avoid the use of toxic or radioactive materials unless desired. Lead or depleted uranium are no longer needed in their typical applications now that dense composites are available. In other applications where some tailored level of toxicity or radiation is needed, the composites can be used successfully.

Enhanced property metal polymer composites can be made by melt forming, injection molding, compression molding, preferable extruding, a heated or melt extrudable composite. Extruded materials may include high viscosity materials that can flow at elevated temperatures but are not in a melt form. Such materials include composites in a melt form. In the composite, the metal particulate is obtained at the highest possible packing by a careful selection of particle size and size distribution. The excluded volume in the particulate is substantially completely occupied by the polymer without reducing the composite density. Using a carefully selected finely divided metal, packing the particulate and combining the particulate with just sufficient polymer such that only the excluded volume (the space left after packing the particle distribution) of the particulate is filled can optimize the high density of the composite material. The particulate has a selected particle size and size distribution that is combined with a polymer selected for compatibility and increased density and processability. In order to maximize composite utility, the majority of the volume of material comes from the metal and polymer such that the total volume of the combined metal and polymer is greater than 95 vol. %, or 98 vol. % of the composite. As the metal particulate and the polymer component increase in density, the composite material increases in density.

The ultimate composite density is largely controlled by efficiency in packing of the metal particulate in the composite and the associated efficiency in filling the unoccupied voids in the densely packed particulate with high density polymer material. The interfacial modifier can aid in closely associating the metal particulate and polymer to maximize density. Density of the composite material to make a weighted strip to balance a motorized boat propeller needs to be greater than 2, 4, 6, 8, or 10 and up to about 18 to 20 gm-cm⁻³.

A true composite is obtained by carefully processing the combined polymer and polymer particulate until density reaches a level showing that using an interfacial modifier to promote composite formation results in enhanced property development and high density. In this disclosure, we rely on density as one important property that can be tailored in the composite, but other useful properties can be designed into the composite.

Most composites have two constituent materials: a polymer binder or polymer matrix in a continuous phase, and reinforcement in a discontinuous phase such as a particle. The reinforcement is usually much stronger and stiffer than the matrix and gives the composite its good properties. The matrix holds the reinforcements in an orderly high-density pattern. Because the reinforcements are discontinuous, the matrix may also help to transfer load among the reinforcements.

Processing can aid in the mixing and filling of the reinforcement metal. To aid in the mixture, an interfacial modifier can help to overcome the forces that prevent the matrix from forming a substantially continuous phase of the composite. The composite properties arise from the intimate association obtained by use of careful processing and manufacture. We believe an interfacial modifier is an organic material that provides an exterior coating on the particulate promoting the close association of polymer and particulate. The modifier is used in an amount of about 0.005 or 0.01 or 0.5 to 1.0 or 2.0 or 3.0 or 4.0 or 5.0 or 6.0 or 7.0 or 8.0 wt. %.

Typically, the composite materials of the embodiment are manufactured using melt extrusion processing (compression and injection molding can also be used) and are also utilized in product formation using melt processing. Typically, in the manufacturing of the high-density materials, a finely divided metal material of correctly selected particle size and size distribution is combined under conditions of heat and temperature with a typically thermoplastic polymer material, are processed until the material attains a maximum density. Alternatively, in the manufacture of the material, the metal or the thermoplastic polymer can be blended with interfacially modifying agents (interfacial modifier) and the modified materials can then be melt processed into the material. The interfacial modifier can make the surface of the particulate more compatible with the polymer. Once the material attains a sufficient density and other properties, the material can be extruded directly into a final product or into a pellet, chip, wafer or other easily processed production raw material. The final product or intermediate chip or pellet can be made extrusion-processing techniques.

In the manufacture of useful products with the composites of the embodiment, the manufactured composite can be obtained in appropriate amounts, subjected to heat and pressure, typically in extruder equipment and then either injection molded, compression molded or extruded into an appropriate useful shape having the correct amount of materials in the appropriate physical configuration.

In the appropriate product design, during composite manufacture or during product manufacture, a pigment or other dye material can be added to the processing equipment. One advantage of this material is that an inorganic dye or pigment can be co-processed resulting in a material that needs no exterior painting or coating to obtain an attractive or decorative appearance. The pigments can be included in the polymer blend, can be uniformly distributed throughout the material and can result in a surface that cannot chip, scar or lose its decorative appearance. One useful pigment material comprises titanium dioxide (TiO₂). This material is extremely non-toxic, is a bright white, finely divided metallic particulate that can be easily combined with either metal particulates and/or polymer composites to enhance the density of the composite material and to provide a white hue to the ultimate composite material.

We have further found that a blend of differing metals or differing particle sizes or both such as a bimetallic blend or a blend of three or more metal particulates can, obtain important composite properties from the blended metals in a polymer composite structure. For example, a tungsten composite or other high-density metal can be blended with a second metal that provides to the relatively stable, non-toxic tungsten material, additional properties including a low degree of radiation in the form of alpha, beta or gamma particles, a low degree of desired cytotoxicity, a change in appearance or other beneficial properties. One advantage of a bimetallic composite is obtained by careful selection of proportions resulting in a tailored density for a particular end use.

The extrudable or injection moldable material having high density that can be extruded into useful shapes include a material having a composite density of about 2, 4, 6, 8, or 10 and up to about 18 to 20 gm-cm⁻³ preferably about 3 to 10 gm-cm⁻³, at an extruded shear rate, in common processing equipment that ranges from about 10 sec⁻¹ to about 500 sec⁻¹, preferably about 10 to about 250 sec⁻¹ at a temperature of greater than about 100° C. or about 130° C. to 240° C.

Combining typically a thermoplastic polymer phase with a reinforcing powder or fiber produces a range of filled materials and, under the correct conditions, can form a true polymer composite. A filled polymer, with the additive as filler, cannot display composite properties. A filler material typically is comprised of inorganic materials that act as either pigments or extenders for the polymer systems. A vast variety of fiber-reinforced composites have been made typically to obtain fiber reinforcement properties to improve the mechanical properties of the polymer in a unique composite.

A large variety of polymer materials can be used with the interfacially modified particulate of the embodiment. For this application, a polymer is a general term covering either a thermoplastic polymer or blends or alloys thereof. We have found that polymer materials that are useful include both condensation polymeric materials and addition or vinyl polymeric materials. Crystalline or semi-crystalline polymers, copolymers, blends and mixtures are useful. Included are both vinyl and condensation polymers, and polymeric alloys thereof. Vinyl polymers are typically manufactured by the polymerization of monomers having an ethylenically unsaturated olefinic group.

Condensation polymers are typically prepared by a condensation polymerization reaction which is typically considered to be a stepwise chemical reaction in which two or more molecules combined, often but not necessarily accompanied by the separation of water or some other simple, typically volatile substance. Such polymers can be formed in a process called polycondensation.

Vinyl polymers include polyethylene, polypropylene, polybutylene, polyvinyl alcohol(PVA), acrylonitrile-butadiene-styrene (ABS), poly(methyl-pentene), (TPX®), polybutylene copolymers, polyacetal resins, polyacrylic resins, homopolymers or copolymers comprising vinyl chloride, vinylidene chloride, fluorocarbon polymers and copolymers, etc. Vinyl polymer polymers include acrylonitrile; polymer of alpha-olefins such as ethylene, high density polyethylene (HDPE), propylene, etc.; chlorinated monomers such as vinyl chloride, vinylidene dichloride, acrylate monomers such as acrylic acid, methylacrylate, methyl methacrylate, acrylamide, hydroxyethyl acrylate, and others; styrenic monomers such as styrene, alpha methyl styrene, vinyl toluene, etc.; vinyl acetate; and other commonly available ethylenically unsaturated monomer compositions.

Also useful are fluoropolymers such as vinylidene fluoride polymers primarily made up of monomers of vinylidene fluoride, including both homo polymers and copolymers. Such copolymers include those containing at least 50 mole percent of vinylidene fluoride copolymerized with at least one comonomer selected from the group consisting of tetrafluoroethylene, trifluoroethylene, chlorotrifluoroethylene, hexafluoropropene, vinyl fluoride, pentafluoropropene, and any other monomer that readily copolymerizes with vinylidene fluoride.

The vinyl polymer has a density of at least 0.85 gm-cm⁻³, however, polymers having a density of greater than 0.96 are useful to enhance overall product density. A density is often up to 1.7 or up to 2 gm-cm⁻³ or can be about 1.5 to 1.95 gm-cm⁻³ depending on metal particulate and end use.

Another class of vinyl thermoplastic includes styrenic copolymers. The term styrenic copolymer indicates that styrene is copolymerized with a second vinyl monomer resulting in a vinyl polymer. Such materials contain at least a 5 mol -% styrene and the balance being 1 or more other vinyl monomers. An important class of these materials is styrene acrylonitrile (SAN) polymers. SAN polymers are random amorphous linear copolymers produced by copolymerizing styrene acrylonitrile and optionally other monomers. Emulsion, suspension and continuous mass polymerization techniques have been used. SAN copolymers possess transparency, excellent thermal properties, good chemical resistance and hardness. These polymers are also characterized by their rigidity, dimensional stability and load bearing capability. Olefin modified SAN's (OSA polymer materials) and acrylic styrene acrylonitrile (ASA polymer materials) are known. These materials are somewhat softer than unmodified SAN's and are ductile, opaque, two phased terpolymers that have surprisingly improved weatherability.

Another class of vinyl thermoplastic polymers are ASA that are random amorphous terpolymers produced either by mass copolymerization or by graft copolymerization. These materials can also be blended or alloyed with a variety of other polymers including polyvinyl chloride, polycarbonate, polymethyl methacrylate and others. An important class of styrene copolymers includes the acrylonitrile-butadiene-styrene monomers (ABS). These polymers are very versatile family of engineering thermoplastics produced by copolymerizing the three monomers. The styrene copolymer family of polymers has a melt index that ranges from about 0.5 to 25, commonly about 0.5 to 20.

Important classes of engineering polymers that are useful include acrylic polymers. Acrylics comprise a broad array of polymers and copolymers in which the major monomeric constituents are an ester acrylate or methacrylate. These polymers are often provided in the form of hard, clear sheet or pellets. A useful acrylic polymer material has a melt index of about 0.5 to 50, commonly about 1 to 30 gm/10 min.

Condensation polymers that are useful include polyamides, polyamide-imide polymers, polyarylsulfones, polycarbonate, polybutylene terephthalate, polybutylene naphthalate, polyetherimides (such as, for example, ULTEM®), polyether sulfones, polyethylene terephthalate, thermoplastic polyimides, polyphenylene ether blends, polyphenylene sulfide, polysulfones, thermoplastic polyurethanes and others. Useful condensation engineering polymers include polycarbonate materials, polyphenyleneoxide materials, and polyester materials including polyethylene terephthalate, polybutylene terephthalate, polyethylene naphthalate and polybutylene naphthalate materials. Useful polycarbonate materials should have a melt index between 0.5 and 7 gm/10 min, commonly between 1 and 5 gm/10 min. Condensation polymers include nylon, phenoxy resins, polyarylether such as polyphenylether, polyphenylsulfide materials; polycarbonate materials, chlorinated polyether resins, polyethersulfone resins, polyphenylene oxide resins, polysulfone resins, polyimide resins, thermoplastic urethane elastomers and many other resin materials. A variety of polyester condensation polymer materials including polyethylene terephthalate, polybutylene terephthalate, polyethylene naphthalate, polylactic acid, polybutylene naphthalate, etc. can be useful in the composites. Such materials have a useful molecular weight characterized by melt flow properties. Useful polyester materials have a viscosity at 265° C. of about 500-2000 cP, commonly about 800-1300 cP. Polyphenylene oxide materials are engineering thermoplastics that are useful at temperature ranges as high as 330° C. Polyphenylene oxide has excellent mechanical properties, dimensional stability, and dielectric characteristics. A useful melt index (ASTM 1238) for the polyphenylene oxide material useful typically ranges from about 1 to 20, commonly about 5 to 10 gm/10 min. The melt viscosity is about 1000 cP at 265° C. Other thermoplastics may be useful depending on the final manufacturing processes of extrusion and sintering.

Polymer blends or polymer alloys can be useful in manufacturing the pellet or linear extrudate of the embodiments. Such alloys typically comprise two miscible polymers or a solution of polymers blended to form a uniform composition. Scientific and commercial progress in polymer blends has led to the realization that important physical property improvements can be made not by developing new polymer material but by forming miscible polymer blends or alloys. A polymer alloy at equilibrium comprises a mixture of two amorphous polymers existing as a single phase of intimately mixed segments of the two macro molecular components. Miscible amorphous polymers form glasses upon sufficient cooling and a homogeneous or miscible polymer blend exhibits a single, composition dependent glass transition temperature (Tg). Immiscible or non-alloyed blend of polymers typically displays two or more glass transition temperatures associated with immiscible polymer phases. In the simplest cases, the properties of polymer alloys reflect a composition weighted average of properties possessed by the components. In general, however, the property dependence on composition varies in a complex way with a property, the nature of the components (glassy, rubbery or semi-crystalline), the thermodynamic state of the blend, and its mechanical state whether molecules and phases are oriented.

The primary requirement for the substantially thermoplastic polymer material is that it retains sufficient thermoplastic properties, such as viscosity and stability, to permit melt processing, such as melt blending, with a particulate, permit formation of linear extrudate pellets, and to permit the composition material or pellet to be extruded or injection molded in a thermoplastic process forming a green product, and to permit formation of a brown and final product. Polymer and polymer alloys are available from a few manufacturers including Dyneon LLC, B.F. Goodrich, G.E., Dow, PolyOne, Mitsui, and DuPont.

In another illustrative example, an ethyl-vinyl-acetate (“EVA”) adhesive, classified as an EVA modified thermoplastic adhesive and obtained from a distributor of glue machinery and products (GIA1041), was used as the polymer matrix. The HB Fuller polyamide has advantages over the EVA adhesive in certain respects due to the fact that the polyamide has less stickiness/tack when handled than the EVA.

The result is a high filled material with a volumetric packing fraction of 0.25 to 0.85, 0.40 to 0.75 or 0.45 to 0.70 using high density particulates that can be readily injection molded or extruded into a weighted strip. In one aspect of the disclosure, a source material for forming a weighted strip for balancing a propeller comprises a metal polymer composite extruded into a strip comprising a polymer phase comprising about 5 to 25 wt. % and 25 to 75 vol. % of the composite; and a metal particulate comprising about 75 to 95 wt. % and 25 to 75 vol. % of the composite and intermixed with the polymer phase, the particulate having a particle size of at least 10 microns; wherein the particulate and polymer phase comprise greater than 90, 95 or 98 vol. % of the composite. The extruded weighted strip comprises a curved top surface with a curvature matching a portion of the internal circumference of the propeller hub and leading edges on the balance weight strip running from 20° to 45° relative to the bottom surface of the weighted strip. Useful ranges of the leading edges are about 20°, 25° 30°, 35°, 40°, up to 45°. The leading edges must maintain a laminar flow over the flow surface of the weighted strip. The curved top surface of the weighted strip comprises an adhesive layer that attaches the weighted strip to the surface of the internal diameter of the propeller hub assembly. The weighted strip can be used for a wide variety of propeller hub assemblies, including multiple sterndrive assemblies, such as those made by Volvo Penta® and Mercury Marine®. Placement can be at any location from which the weight can be mechanically kept in place. The placement can be inside a hollow hub.

The adhesive layer for attaching the weighted strip to the propeller assembly can be any adhesive with a melting point of above 100° C. The adhesive, for example, can be epoxy-based, a polyester or a polyurethane. The adhesive can be applied during the propeller balancing operation using known hot melt equipment and procedures. In another embodiment the adhesive can be applied and protected by a release liner, and then the weighted strip can be applied during the propeller balancing operation. For two-part adhesive systems, one part can be pre-applied to the weighted strip, protected by a release liner, and then the second part of the adhesive can be applied during the propeller balancing operation. Any adhesive surface can comprise a protective release liner covering the entire adhesive surface to prevent contamination and loss of adhesive bonding.

In another aspect of the disclosure, the composite in the above-outlined source material further comprises an interfacial modifier present in the composite and at least partially coating the particulate.

An interfacial modifier can be an organo-metallic material that provides an exterior coating on the particulate promoting the close association, but not attachment or bonding, of polymer to particulate and particulate to particulate. The composite properties, such as viscoelasticity and rheology, arise from the intimate association of the polymer and particulate obtained by use of careful processing and manufacture.

An interfacial modifier is an organic material, in some examples an organo-metallic material, that provides an exterior and uniform coating on the particulate to provide a surface that can associate with the polymer promoting the close association of polymer and particulate but with no reactive bonding, such as covalent bonding for example, of polymer to particulate, particulate to particulate, or particulate to a different particulate, such as a glass fiber or a glass bubble. The lack of reactive bonding between the components of the composite leads to the formation of the novel composite—such as high packing fraction, commercially useful rheology, viscoelastic properties, and surface inertness of the particulate. These characteristics can be readily observed when the composite with interfacially modified coated particulate is compared to a composite comprising particulate lacking the interfacial modifier coating or to particulate that is reactively coupled to other particulate or polymer.

In one embodiment, the coating of interfacial modifier at least partially covers the surface of the particulate.

In another embodiment, the coating of interfacial modifier continuously and uniformly covers the surface of the particulate, in a continuous coating phase layer.

Interfacial modifiers used in the application fall into broad categories including, for example, titanate compounds, zirconate compounds, hafnium compounds, samarium compounds, strontium compounds, neodymium compounds, yttrium compounds, phosphonate compounds, aluminate compounds and zinc compounds. Aluminates, phosphonates, titanates and zirconates that are useful contain from about 1 to about 3 ligands comprising hydrocarbyl phosphate esters and/or hydrocarbyl sulfonate esters and about 1 to 3 hydrocarbyl ligands which may further contain unsaturation and heteroatoms such as oxygen, nitrogen and sulfur.

In one embodiment, the interfacial modifier that can be used is a type of organo-metallic material such as organo-cobalt, organo-iron, organo-nickel, organo-titanate, organo-aluminate organo-strontium, organo-neodymium, organo-yttrium, organo-zinc or organo-zirconate. The specific type of organo-titanate, organo-aluminates, organo-strontium, organo-neodymium, organo-yttrium, organo-zirconates which can be used and which can be referred to as organo-metallic compounds are distinguished by the presence of at least one hydrolysable group and at least one organic moiety. Mixtures of the organo-metallic materials may be used. The mixture of the interfacial modifiers may be applied inter- or intra- particulate, which means at least one particulate may has more than one interfacial modifier coating the surface (intra), or more than one interfacial modifier coating may be applied to different particulates or particulate size distributions (inter).

Certain of these types of compounds may be defined by the following general formula:

M(R₁)ₙ(R₂)ₘ

wherein M is a central atom selected from such metals as, for example, Ti, Al, and Zr and other metal centers; R₁ is a hydrolysable group; R₂ is a group consisting of an organic moiety, preferably an organic group that is non-reactive with polymer or other film former; wherein the sum of m+n must equal the coordination number of the central atom and where n is an integer≥1 and m is an integer≥1. Particularly R₁ is an alkoxy group having less than 12 carbon atoms. Other useful groups are those alkoxy groups, which have less than 6 carbons, and alkoxy groups having 1-3 C atoms. R₂ is an organic group including between 6-30, preferably 10-24 carbon atoms optionally including one or more hetero atoms selected from the group consisting of N, 0, S and P. R₂ is a group consisting of an organic moiety, which is not easily hydrolyzed and is often lipophilic and can be a chain of an alkyl, ether, ester, phospho-alkyl, phospho-alkyl, phospho-lipid, or phospho-amine. The phosphorus may be present as phosphate, pyrophosphato, or phosphito groups. Furthermore, R₂ may be linear, branched, cyclic, or aromatic. R₂ is substantially unreactive, i.e. not providing attachment or bonding, to other particles or particulate within the composite material. R₂ is non-reactive to the polymer like R₁.

Titanates provide antioxidant properties and can modify or control cure chemistry. A useful titanate material is 2-propanolato, tris isooctadecanoato-O-titanium IV, an isopropyl triisostearoyl titanate. Zirconate provides excellent coating and reduces formation of off color in formulated thermoplastic materials. A useful zirconate material is neopentyl (diallyl) oxy-tri (dioctyl) phosphato-zirconate.

The use of an interfacial modifier results in workable thermoplastic viscosity and improved structural properties in a final use such as a structural member or shaped article. Minimal amounts of the modifier can be used including about 0.005 to 8 wt.-%, about 0.01 to 6 wt.-%, about 0.02 to 5 wt.-%, or about 0.02 to 3 wt. %. The IM coating can be formed as a coating of at least 3 molecular layers or at least about 50 or about 100 to 500 or about 100 to 1000 or about 100 to 1500 angstroms (A). The claimed composites with increased loadings of particulate can be safely compounded and melt processed formed into high strength structural members. The interfacial modification technology depends on the ability to isolate the particulates from the continuous polymer phase. The isolation is obtained from a continuous molecular layer(s) of interfacial modifier to be distributed over the blended particulates surfaces. From another perspective, the IM coated particulates are immiscible in the polymer phase. Once this layer is applied, the behavior at the interface of the interfacial modifier coating on the particle to polymer dominates and defines the physical properties of the composite and the shaped or structural article (e.g. modulus, tensile, rheology, packing fraction and elongation behavior) while the bulk nature of the particulate dominates the bulk material characteristics of the composite (e.g. density, thermal conductivity, compressive strength). The correlation of particulate bulk properties to that of the final composite is especially strong due to the high-volume percentage loadings of discontinuous phase, such as particulate, associated with the technology.

The particulates are coated with IM to obtain the processing and physical properties needed. Once coated, the particulate exterior appears to be the IM composition to the polymer while the metal particulate character is hidden. The organic nature of the IM coating changes the nature of the interaction between the particulate surface and the polymer phase. The polymer does not easily associate with the inorganic particulate surface, but much more easily associates with the organic nature of the IM coated surfaces of the inorganic particulates. The blended IM coated particulate mixes well with the polymer and can achieve greater composite uniformity and particulate loadings.

The benefit of interfacial modification on a fully coated particulate is independent of overall particulate shape. The current upper limit constraint is associated with challenges of successful dispersion of particulates within laboratory compounding equipment without significantly damaging the high aspect ratio particulates.

In an embodiment of high output production, high density composite could be used for propeller weighted strips for a motorized boat. The weight comprises attachment means and an article of mass of the composite. The weight can be attached with conventional clips or adhered to the propeller with an adhesive. An example composite with these characteristics might include a combination of stainless steel particulate, a thermoplastic polymer as a binder and a zirconate or titanium-based interfacial modifier. The weighted strip could be the result of injection, extrusion, molding, or bulk molding parts.

The boat propeller weights of a embodiment can be a linear extrudate with a regular cross section and an arbitrary length to achieve the appropriate weight for balancing the propeller. In one embodiment the weight can be cut from a length of extrudate of indeterminate length to obtain a weigh of exact weight needed to balance the propeller at operational rpms. The boat propeller weight can be coextruded with a dispersed colorant or exterior decorative or informational cap stock layer. The mass of the weights can range from 1 to 250 grams and 2 to 100 grams. A premade weight can also be selected from a collection of weights of various sizes. The upper cross section is adjusted so that the upper cross-section curvature of the weighted balance strip matches at least a portion of the inner circumference of the propeller hub. This matching the curvature of the strip to the circumference of the surface of the inner hub improves adhesion of the weighted strip to the circular internal diameter of the propeller hub. Further the cross-section has smoothed corners, leading edges, to provide a laminar flow over the propeller surfaces and to suppress water turbulence and cavitation causing vibration and other deleterious effects resulting from high motor rpms.

Not meaning to be bound by theory, the leading edges, the smoothed corners, on the propeller weight strip are meant to maintain a low Reynolds number (Re). A low Re provides a stable laminar flow of a fluid (water) over the surface of the propeller weight. High Res lead to increasing turbulence, cavitation and a greater propensity to undesirable vibration around the propeller. To enhance the area of adhesion to the propeller mount the larger curved dimension of the top surface of the rectangular weighted strip is pressed against the inside circumference of the internal diameter of the propeller hub assembly. The rectangular cross-sectional profile, the weighted strip, larger dimension can be 1 mm to 5 cm and the smaller dimension can be 1 mm to 3 cm.

The boat propeller weights of the embodiment can be attached with adhesive means including an adhesive layer, an adhesive tape or a separate addition of adhesive. A release liner can protect the adhesive surface of the adhesive or of the adhesive tape. Other means of attachment such a clip or clip and adhesive are useful. The viscoelastic properties of the composition make the boat propeller weight strips ideal for adhesive attachment to a propeller mount.

### Detailed Description of the Figures

Typical motorized boat propellers often comprise a hub and two or more blades attached thereto. Within the hub is an inner hub having a drive surface adapted to the drive shaft from the motor. The inner hub and propeller or drive shaft are fixed in place by a spline connection. The inner hub is rigidly fixed to the hub and often comprises an exhaust path for combustion gases.

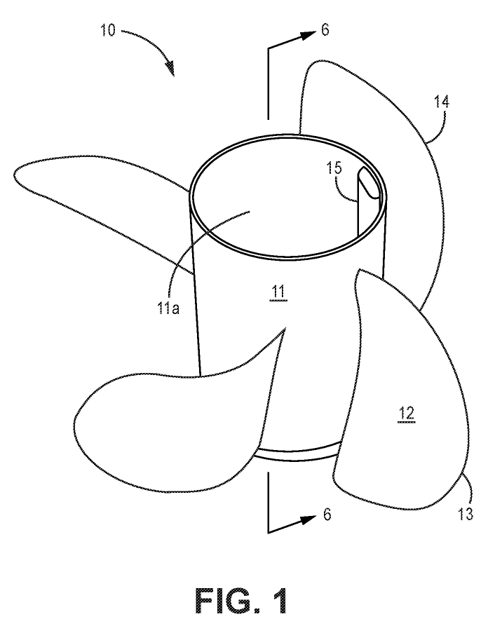

FIG. 1 is an isometric view of the trailing portion of the propeller 10. The propeller 10 includes an outer hub 11 and blades 12. Each blade has a blade leading edge 13 and a blade trailing edge 14 to provide propulsion through water. The balance weight 15 is shown fixedly attached to the inside curved surface of the outer hub 11. The balance weight 15 is attached to the hub through an adhesive strip (not shown) to the inner curved surface 11a of the circumference of outer hub 11. Balance weight(s) 15 may be position and attached anywhere along the circumference of inner curved surface 11a. Within the outer hub 11 is typically positioned other hardware elements including a hub exhaust, support webs, and other mechanical aspects (not shown) necessary for the operation of the propeller 10.

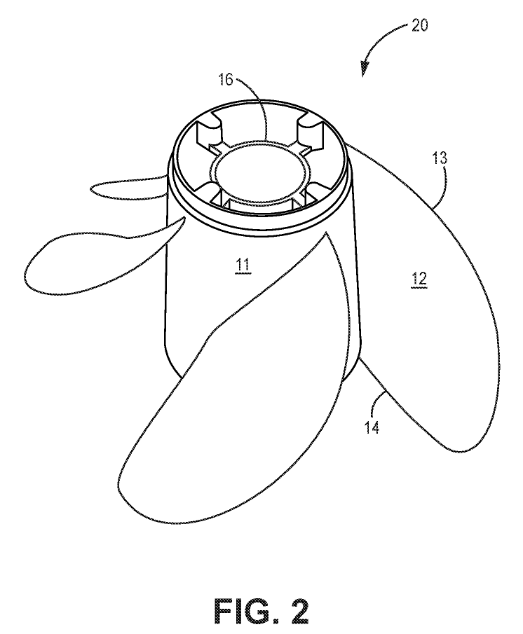

FIG. 2 is an isometric view 20 of the leading edge of the propeller system. In addition to the figure elements of FIG. 1, an inner hub 16 structure within the outer hub 11 is also shown. Within the inner hub is a drive member that can be attached to a boat motor drive with a splined system (not shown).

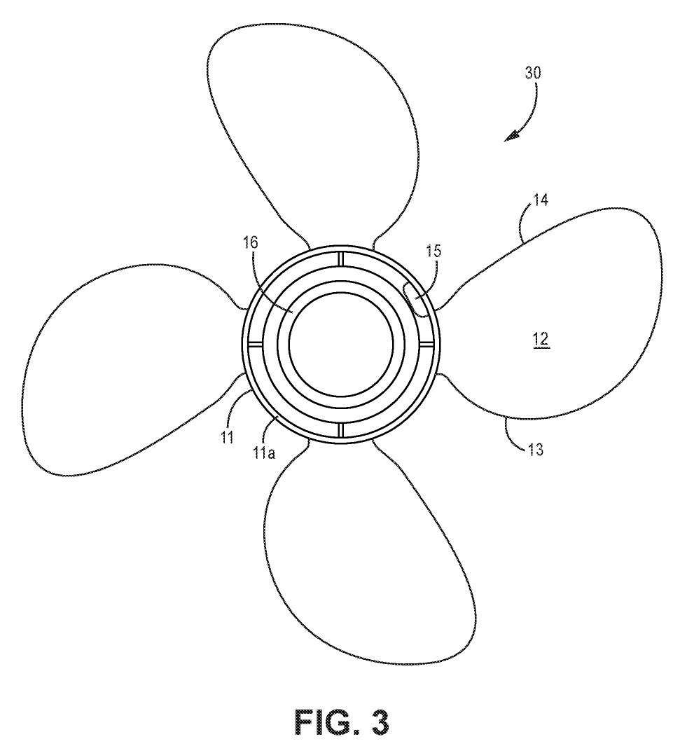

FIG. 3 is a planar view 30 of the trailing portion of the propeller. In addition to balance weight 15 and the elements shown in FIG. 1 the figure shows details of the inner hub 16, the outer hub 11, blade leading edges 14, blade trailing edges 13 and the motor drive (not shown).

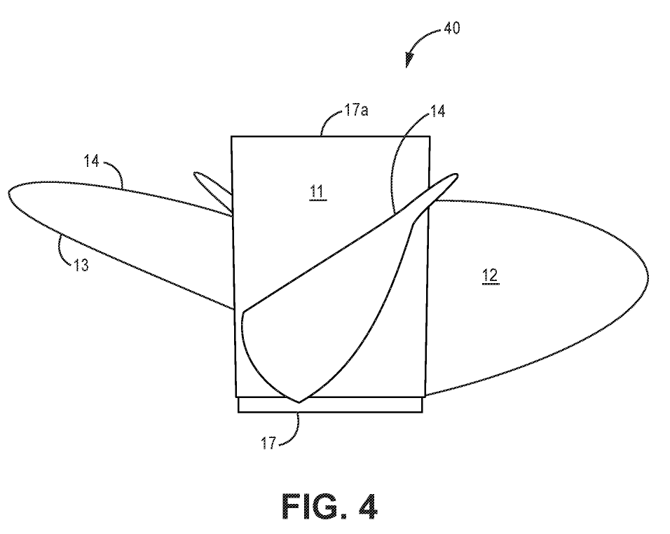

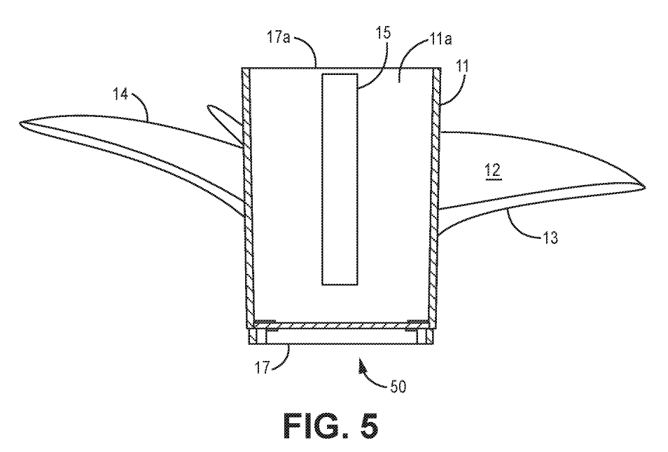

FIG. 4 is the side view 40 of a propeller system. In this view the positioning of the balancing strip inside on the inner curved surface 11a of outer hub 11 cannot be shown. However, the figure shows the outer hub 11, the leading edge of the outer hub 17, the trailing edge of the outer hub 17a, blade leading edge 13, and blade trailing edge 14. FIG. 5 shows a planar view of the leading edge of the propeller system 50. FIG. 5 includes the balance weight 15, the blade 12, blade leading edge 13, blade trailing edge 14, the leading hub edge 17 and the trailing hub edge 17a. The balance weight(s) (weighted strip(s)) 15 may be any appropriate length and weight that balances the propeller assembly. The balance weight is attached to the inner curved surface 11a of outer hub 11. Attachment may be by any permanent means, such as, for example, by adhesive, adhesive clip, or clip.

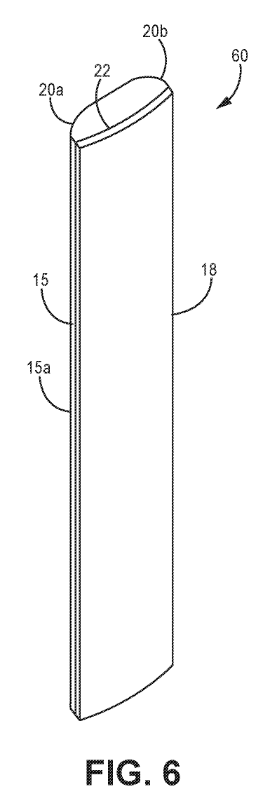

FIG. 6 is an isometric view of the balance weight and adhesive strip system 60. The strip includes the weighted balance composite material 15 and the adhesive strip 18, which is a layer over curved surface 15a, used to adhere the balance weight to the inner curved surface 11a of the circumference of outer hub 11. In use the adhesive strip can be protected until positioned by a release liner (not shown). The weighted balance material has strip leading edge 20A and strip trailing edge 20B. These edges are angled or rounded to less than 45° to provide a laminar flow of water over the water contact surface 15b which is the basal surface of the balance weight exposed to water flow.

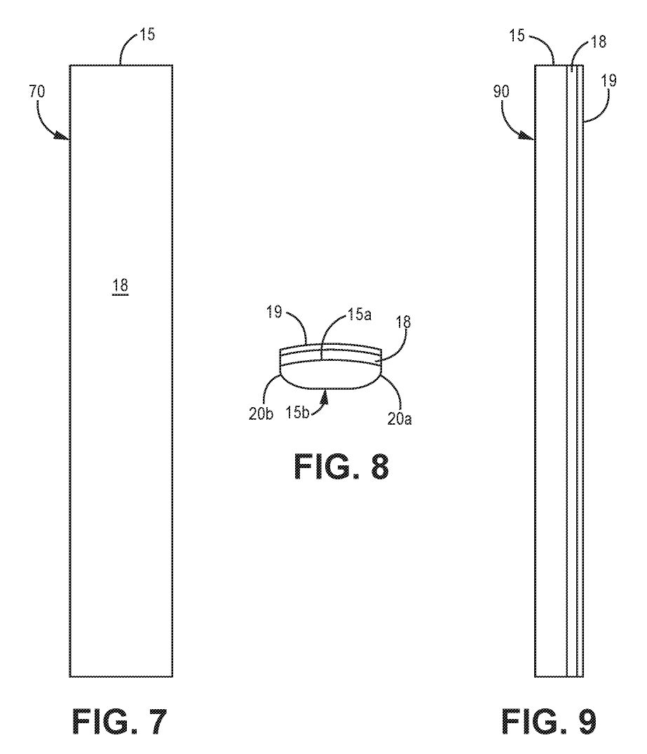

FIG. 7 is a top view 70 of the weighted balance strip 60. The balance weight includes the composite material itself 15, and the release liner 19 covering and hiding the adhesive strip (not shown).

FIG. 8 is an end view of the balance weight. The weight includes the weight mass 15b, and adhesive strip 18, which in turn is covered by a protective release liner 19. The weight has strip leading edge 20A and strip trail edge 20B that are angled and rounded to less than 45° relative to the adhesive containing curved surface 15a that is affixed to the curved inner curved surface 11a of outer hub 11 (not shown). The angle of edges are less than 45° relative to the inner surface of outer hub 11 so that when the propeller assembly turns at a high rpm, there is laminar, not turbulent, water flow over water contact surface 15b of the weighted balance strip 60. In many cases the Reynolds Number over the weight is less than 4000 and often less than 2300.

FIG. 9 is a side view of the balance weight 90. The weight includes the balance weight composite material 15 the adhesive strip 18 and the protective release liner 19.

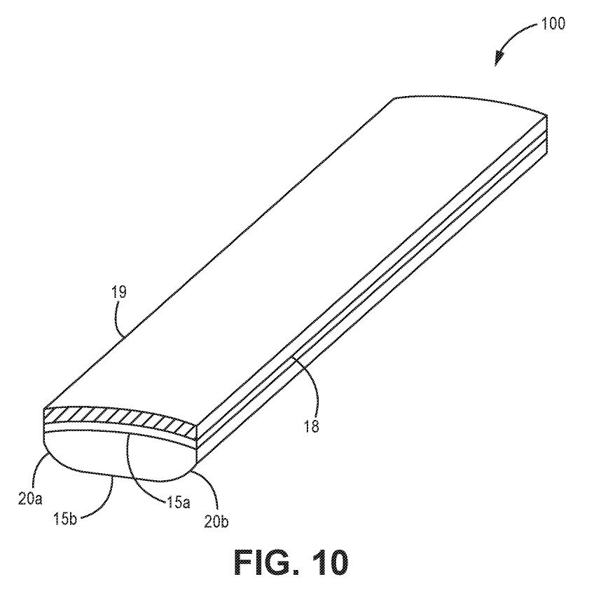

FIG. 10 is an isometric view of the balancing weight 100. The balance weight 100 includes the balance weight 15 composite material , the adhesive strip 18 used to position the balance weight on the inner curved surface 11a (not shown) of the outer hub 11 (not shown), the release liner 19 used to protect the adhesive strip 18 before placement, the strip leading edge that is less than 45° of the balance weight strip 20A and the strip trailing edge 20b that are both less than 45° of the balance weight strip 20B. The balance weight when adhered to the inner curved surface 11a (not shown) of the outer hub 11 (not shown) includes water contact surface 15b (opposite the adhesive attachment surface 19 to the inner curved surface 11a of outer hub 11) that suppresses or reduces turbulence by producing laminar flow over the water contact surface 15b of the weight 15. The weight is placed on the inner surface of the hub using a curved contact surface 15a of the balance weight.

The Figures. show propeller and balance weight strip applications of the embodiment. A boat propeller balance weight strip includes a portion of a linear extrudate comprising a composite of a high-density metal particulate and polymer, having an adhesive strip on a curved top surface that can match a portion of the circumference of a hub and attach the boat propeller weighted strip to the inside of the internal diameter of the propeller hub. The linear extrudate can be extruded in a continuously and cut into the individual weighted strips. The composite metal polymer material forming the linear extrudate is flexible and viscoelastic. The weighted strip can have a curved top surface that conforms to a portion of the circumference of any propeller hub assembly. The opposite surface is characterized by leading edges on either side and that permit a laminar flow of a fluid, such as, for example, water, across this exposed surface. These leading edges are in no more than 45° relative from flat bottom surface of the balance strip, in some embodiments the leading edges can be 20°, 25° 30°, 35°, 40°, or 45°. Such an angle on the leading edges can produce a Re (Reynolds number) of less than 4000 and forms a substantially laminar flow over the exposed surface of weighted strip. The weighted strip for boat propeller balancing can also be mounted by a clip—not shown.

| | | |
|---|---|---|
| FIG. 1 | | |
| Cross section view | 6 | Shows weight placement |
| Isometric Trailing | 10 | Direction of water flow |
| View Propeller | | |
| Outer hub | 11 | Weight Placement location on inner |
| | | surface |
| Inner Curved | 11a | |
| Surface | | |
| Blade | 12 | Motive force |
| Blade leading | 13 | |
| edge | | |
| Blade Trailing | 14 | |
| edge | | |
| Balance weight | 15 | Selected Weight Placed to obtain |
| | | smooth rotation; laminar flow over |
| | | blades. |
| Adhesive strip | not shown | Adhesive can fix the weight in place |
| Inner hub exhaust | Not | Exhaust path if needed |
| | shown | |
| FIG. 2 | | |
| Isometric Leading | 20 | Direction of water flow |
| view propeller | | |
| Inner hub | 16 | |
| Drive | Not | Motor drive interface directs |
| | shown | rotational force form motor |
| FIG. 3 | | |
| Planar trailing | 30 | Direction of water flow |
| view propeller | | |
| Inner hub | 16 | |
| Outer Hub | 11 | |
| Inner Curved | 11a | Weight placement surface |
| Surface | | |
| Balance Weight | 15 | |
| Drive | Not | Motor drive interface directs |
| | shown | rotational force form motor |
| FIG. 4 | | |
| side view | 40 | Direction of water flow |
| propeller | | |
| Leading edge hub | 17 | |
| Trailing edge hub | 17a | |
| FIG. 5 | | |
| Leading view | 50 | Direction of water flow |
| propeller | | |
| Leading edge hub | 17 | |
| Trailing edge hub | 17a | |
| Balance Weight | 15 | |
| FIG. 6 | | |
| Isometric adhesive | 60 | An embodiment of balance weight |
| strip | | |
| Balance weight | 15 | Composite |
| Curved Contact | 22 | |
| Surface | | |
| Water Contact | 15a | |
| Surface | | |
| Strip leading edge | 20a | |
| Strip trailing edge | 20b | |
| Adhesive strip | 18 | Placement Adhesive |
| Release liner | Not | Adhesive Protection |
| | shown | |
| FIG. 7 | | |
| top adhesive strip | 70 | An embodiment of balance weight |
| Balance weight | 15 | Composite |
| Adhesive strip | 18 | Placement Adhesive |
| Release liner | Not | Adhesive Protection |
| | shown | |
| FIG. 8 | | |
| End view adhesive | 80 | An embodiment of balance weight |
| strip | | |
| Balance weight | 15a | Composite; curved surface to fit hub |
| Balance weight | 15b | Composite; curved water contact |
| | | surface |
| Strip leading edge | 20a | |
| Strip trailing edge | 20b | |
| Adhesive strip | 18 | Placement Adhesive |
| Release liner | 19 | Adhesive Protection |
| FIG. 9 | | |
| Balance weight | 15 | Composite |
| Adhesive strip | 18 | Placement Adhesive |
| Release liner | 19 | Adhesive Protection |
| FIG. 10 | | |
| Balance weight | 100 | An embodiment of balance weight |
| Balance weight | 15a | Composite; curved surface to fit hub |
| Balance weight | 15b | Composite; curved water contact |
| | | surface |
| Adhesive strip | 18 | Placement Adhesive |
| Release liner | 19 | Adhesive Protection |
| Leading edge | 20a | On weight strip |
| Trailing edge | 20b | On weight strip |

The process to mount the boat propeller weighted strip using a semi-automated system, such as the 3M™ Wheel Weight System modified for boat propellers, is described as follows:
1) Select the balancer setting such as clip/clip, clip/tape, or tape;
2) Measure width and weight of propeller;
3) Input measurements into balancer;
4) Balance the propeller on the balancer by spinning;
5) After spinning, the balancer displays the out-of-balance weight and the out-of-balance location(s) on the boat propeller;
6) Clean the location(s) on the propeller where the metal polymer composite propeller weighted strip(s) will be placed;
7) Cut the propeller weighted strip material to the needed weight. Precision can be to 1 gram or less;
8) Center the propeller weighted strips(s) to the correct position on the propeller body. In some applications this position can be inside the propeller hub;
9) Pre-bend the propeller weighted strips(s) to conform to fit the curvature of a propeller assembly surface, such as for example, the internal diameter of the hub assembly;
10) Attach the propeller weighted(s) strip to the propeller area that is out-of-balance via an adhesive strip on the curved top surface of the weight. Smooth the leading edges of weight strip so that they are less than 45° relative to the base of the propeller hub to obtain maximum water laminar flow and if needed exhaust flow character in use;
11) Recheck the balance of the propeller with the balancing weight strip attached.

In one embodiment, the weighted strip comprises a composite of polyvinyl chloride, stainless steel metal particulate coated with an interfacial modifier on the metal particulate surface, and an adhesive strip on the curved top surface of the weighted strip with an optional release liner.

The advantages of the boat propeller weight strip are the elimination of repetitive grinding of excess material from the propeller to obtain the proper propeller balance, and the speed, simplicity of the process to balance a boat propeller with a precisely measured and placed propeller weighted strip having a Re that provides laminar fresh or salt water flow over the propeller weight strip.

The complete disclosure of all patents, patent applications, and publications cited herein are incorporated by reference. If any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The disclosure is not to be limited to the exact details shown and described, for variations obvious to one skilled in the art will be included within the disclosure defined by the claims.

All scientific and technical terms used herein have meanings commonly used in the art unless otherwise specified. The definitions provided herein are to facilitate understanding of certain terms used frequently herein and are not meant to limit the scope of the present disclosure.

As used in this specification and the appended claims, the term “or” is generally employed in its inclusive sense including “and/or” unless the content clearly dictates otherwise.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

The terms “comprise or comprises” and variations thereof do not have a limiting meaning where these terms appear in the description and claims.

“Include,” “including,” or like terms means encompassing but not limited to, that is, including and not exclusive.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present disclosure. At the very least, and not as an attempt to limit the doctrine of equivalents to the scope of the claims, each numerical parameter should at least be construed considering the number of reported significant digits and by applying ordinary rounding techniques.

Notwithstanding that the numerical ranges and parameters setting forth the broad scope of the disclosure are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

While the above specification shows an enabling disclosure of the composite technology of the disclosure, other embodiments may be made without departing from the spirit and scope of the claimed technology. Accordingly, the disclosed technology is embodied in the claims hereinafter appended. While the above specification shows an enabling disclosure of the composite technology of the system, other embodiments of the system components may be made without departing from the spirit and scope of the claimed subject matter.

We claim:

1. A marine propeller comprising an outer hub surrounding a motor drive portion and two or more blades affixed thereto; wherein the propeller comprises a balance weight comprising a thermoplastic composite material affixed on the propeller, the thermoplastic composite material comprising:
(a) a thermoplastic polymer phase comprising about 5 to 25 wt. % and 25 to 75 vol. % of the composite; and
(b) a metal particulate comprising about 75 to 95 wt. % and 25 to 75 vol. % of the composite and intermixed with the polymer phase, the particulate having a particle size where no more than 10 wt. % of the particles are under 10 microns; wherein the particulate and polymer phase are formed into the balance weight, the balance weight having a Reynolds number producing a laminar flow across the strip during operation of the boat propeller.

2. The propeller of claim 1 wherein the balance weight is placed on an inner surface of the outer hub.

3. The propeller of claim 2 wherein the balance weight has a hub contact surface that is curved to be complementary to a curved surface of the outer hub.

4. The propeller of claim 1, wherein the composite has a coating of an interfacial modifier on a surface of the metal particulate.

5. A thermoplastic composite material adapted for forming a weighted strip placed on a marine propeller, the thermoplastic composite material comprising:
(a) a thermoplastic polymer phase comprising about 5 to 25 wt. % and 25 to 75 vol. % of the composite; and
(b) a metal particulate comprising about 75 to 95 wt. % and 25 to 75 vol. % of the composite and intermixed with the polymer phase, the particulate having a particle size where no more than 10 wt. % of the particles are under 10 microns; wherein the particulate and polymer phase are formed into the weighted strip, the weighted strip having a Reynolds number producing a laminar flow across the strip during operation of the boat propeller.

6. The material of claim 5, wherein the composite has a coating of an interfacial modifier on a surface of the metal particulate.

7. The strip of claim 5, having a curvature on at least one surface.

8. The strip of claim 5, having a leading edge that is less than 45°.

9. The strip of claim 3 having a shape that is round, square or rectangular.

10. A process of manufacturing a weighted strip to balance a motorized marine propeller from a metal particulate and polymer composite, the process comprising:
a. combining a thermoplastic polymer phase;
comprising about 5 to 25 wt. % and 25 to 75 vol. % of the composite; and
b. mixing a metal particulate comprising about 75 to 95 wt. % and 25 to 75 vol. % of the composite with the polymer phase, the particulate having a particle size of no more than 10 wt. % under 10 microns; wherein the particulate and polymer phase comprises greater than 95 vol. % of the composite;
c. extruding the composite into a linear extrudate;
m. selecting a balancer setting such as clip/clip, clip/tape, or tape;
n. measuring a width and a weight of the propeller;
o. placing the propeller on the balancer;
p. determining an out-of-balance weight and a location(s) on the propeller;
q. cutting the weighted strip material to a needed weight;
r. locating the propeller weight strips(s) to the correct position on the propeller hub; and
s. Placing the weighted strip in a balancing position on the hub.

11. The process of claim 10, wherein the weighted strip can be a rectangular, circular or square shape.

12. The process of claim 10 comprising bending the weighted strip(s) to conform to a curvature of the top surface of the propeller weight to fit at least a portion of the curvature of an inner surface of a boat propeller hub.

13. The process of claim 10 smoothing a leading edge(s) of the weight strip so that the leading edge(s) is less than 45° relative to the base of the propeller hub.

14. The process of claim 10 comprising checking the balance of the propeller with the weighted strip.

15. A weighted strip of manufacture made by the process of claim 10; wherein the weighted strip has a laminar flow over a surface the weighted strip.

16. The weighted strip of manufacture made by the process of claim 10; wherein the weighted strip has a laminar flow over the surface the weighted strip has a Reynolds number of less 4000.

17. The process of claim 10, wherein the metal particulate of composite comprises a coating of an interfacial modifier on the surface of the particulate.

18. A propeller comprising an outer hub and two or more blades affixed thereto; wherein the propeller comprises a balance weight comprising a thermoplastic composite material affixed on the propeller, the thermoplastic composite material comprising:
(a) a thermoplastic polymer phase comprising about 5 to 25 wt. % and 25 to 75 vol. % of the composite; and
(b) a metal particulate comprising about 75 to 95 wt. % and 25 to 75 vol. % of the composite and intermixed with the polymer phase, the particulate having a particle size where no more than 10 wt. % of the particles are under 10 microns; wherein the particulate and polymer phase are formed into the balance weight, the balance weight having a Reynolds number producing a laminar flow across the strip during operation of the propeller.

19. The propeller of claim 18 wherein the balance weight is placed on an inner surface of the outer hub.

20. The propeller of claim 19 wherein the balance weight has a hub contact surface that is curved to be complementary to a curved surface of the outer hub.
